(19) United States
(12) Patent Application Publication
(10) Pub. No.: US 2023/0322120 A1
(43) Pub. Date: Oct. 12, 2023

(54) CHARGING INFRASTRUCTURE FOR ELECTRIC VEHICLE AND OPERATING METHOD

(71) Applicant: AUDI AG, lngolstadt (DE)

(72) Inventors: Erdal ACIKGOEZ, Reichertshofen (DE); Joerg SCHMIDT, lngolstadt (DE)

(21) Appl. No.: 18/188,344

(22) Filed: Mar. 22, 2023

(30) Foreign Application Priority Data
Mar. 23, 2022 (DE) 102022106823.4

(51) Int. Cl. H02J 7/00; B60L 53/68; B60L 53/66; B60L 53/65

(52) U.S. Cl. CPC B60L 53/68; B60L 53/65; B60L 53/66; H02J 7/0071

(57) ABSTRACT

A method of operating a charging infrastructure for electric vehicles is provided. The method includes creating, by a central backend server of the charging infrastructure, a global charging schedule for the electric vehicles and charging stations of the charging infrastructure; determining, by the central backend server of the charging infrastructure, a particular one of the charging stations using the global charging schedule; sending, by the central backend server of the charging infrastructure, data indicating the particular one of the charging stations to one of the electric vehicles; and charging, by the particular one of the charging stations of the charging infrastructure, a traction battery of the one of the electric vehicles that is connected to the particular one of the charging stations.

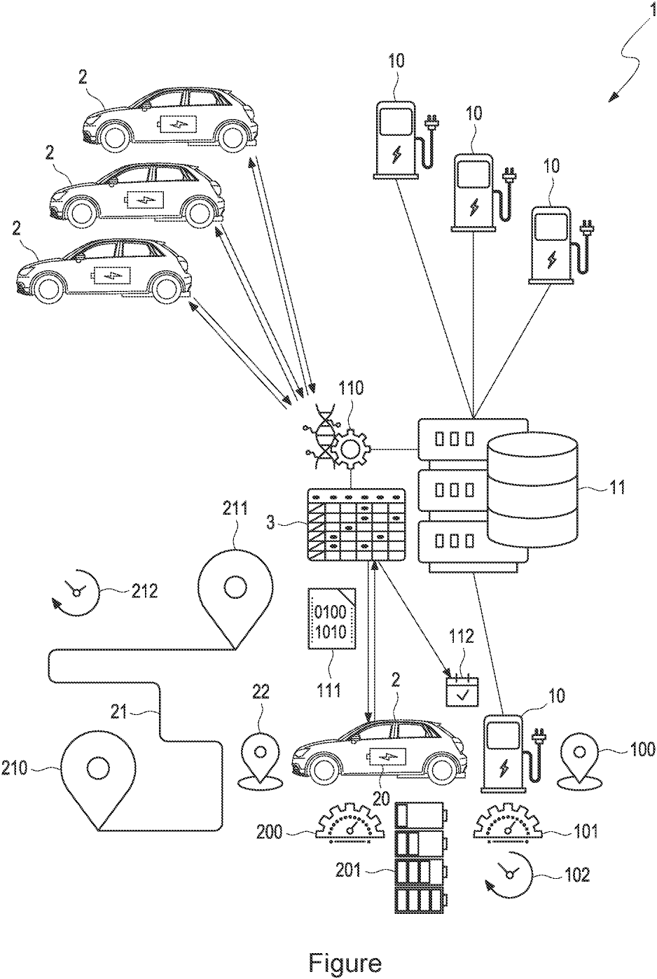

### BACKGROUND

### Technical Field

The disclosure relates to a method of operating a charging infrastructure for electric vehicles, in which an electric vehicle during travel from a starting location to a destination drives to a particular charging station of a charging infrastructure and the particular charging station charges a traction battery of the electric vehicle which is connected to the particular charging station. Moreover, the disclosure relates to a charging infrastructure for electric vehicles.

### Description of the Related Art

Charging infrastructures and corresponding operating methods in various configurations are part of the prior art and serve for providing electric energy to charge the traction batteries of electric vehicles. A traction battery of an electric vehicle is charged by connecting the traction battery in electrically conductive manner across a charger of the electric vehicle to a charging station of a charging infrastructure.

As compared to a filling of the tank of motor vehicles driven by combustion engines with fluid fuels, usually fossil fuels, the charging of a traction battery requires much more time. Especially during a long trip of an electric vehicle, one must expect a long waiting time, during which the traction battery is charged in order to continue driving. Every trip of the electric vehicle with a travel route longer than the range of the electric vehicle requires a corresponding long interruption of the trip.

However, practice shows us that in many instances a charging station intended for the charging may be occupied by another electric vehicle, so that further waiting time is added to the necessary waiting time required as a result of the unavoidable length of charging. The intended charging station may even have a waiting line of multiple electric vehicles, so that a further waiting time of many hours may even result.

Charging infrastructures for electric vehicles have at present less surface density of charging stations as compared to traditional gas stations. Consequently, every further charging station neighboring an occupied charging station may lie outside the remaining range of an electric vehicle in need of a charge. Accordingly, an electric vehicle is prevented from moving on from the occupied charging station to another neighboring charging station in order to reduce the waiting time before charging the traction battery.

Operating methods of charging infrastructures should therefore assure whenever possible that a charging station intended for an electric vehicle in need of a charge for the charging of the traction battery is not occupied when the electric vehicle reaches the intended charging station.

Thus, CN 107 392 336 A and KR 2013 0094919 each disclose an operating method for a charging infrastructure for electric vehicles, in which a central backend server of a charging infrastructure reserves a charging station of the charging infrastructure for the electric vehicle that has been selected by the driver of an electric vehicle and provided for a charging.

However, the driver of the electric vehicle can already be overwhelmed in providing the optimal charging station in regard to a travel route for a trip of the electric vehicle.

In order to ease the burden on the driver in this regard, EP 3 702 979 Al discloses an operating method for a charging infrastructure for electric vehicles in which a central backend server of the charging infrastructure determines and reserves for an electric vehicle a charging station in dependence on the state of charge of a traction battery of the electric vehicle, the destination of a trip of the electric vehicle, and the travel route for the trip of an electric vehicle.

However, the mentioned known methods for operating a charging infrastructure for electric vehicles reach their limits in the foreseeable growing multitude of electric vehicles.

### BRIEF SUMMARY

Embodiments of the disclosure provide a method of operating a charging infrastructure for electric vehicles that avoids or at least shortens the waiting time needed for a plurality of electric vehicles prior to charging of the traction battery. Embodiments of the disclosure also provide a charging infrastructure for electric vehicles.

One embodiment of the disclosure is a method of operating a charging infrastructure for electric vehicles, in which an electric vehicle during travel from a starting location to a destination drives to a particular charging station of a charging infrastructure and the charging station charges a traction battery of the electric vehicle which is connected to the particular charging station. For the charging of the traction battery, the charging station is connected in electrically conductive manner, especially by way of a charging cable, across a charger of the electric vehicle to the traction battery. Such operating methods for charging infrastructures are very common, so that many application possibilities exist for the disclosure.

According to the disclosure, a central backend server of the charging infrastructure dynamically creates in real time a global charging schedule for a plurality of electric vehicles including the electric vehicle and for a plurality of charging stations of the charging infrastructure including the charging station, the central backend server determines the particular charging station with the aid of the global charging schedule so created, and the central backend server sends data determining the charging station so identified to the electric vehicle. By way of the transmitted data, the central backend server assigns the particular charging station to the electric vehicle. The driver of the electric vehicle need not himself select any charging station of the charging infrastructure or provide for the charging of the traction battery.

The global charging schedule so created includes and takes account of all charging stations and all electric vehicles, so that the central backend server assures a flexibility and a collectivity of the operation of the charging infrastructure. Thanks to the flexibility and the collectivity, charging processes of multiple electric vehicles can be attuned to each other in space and in time.

The central backend server can update the global charging schedule so created in real time and in particular adapt it at any time to unforeseeable events. For example, the central backend server can use the global charging schedule so created to quickly assign a charging station not occupied by a first electric vehicle on account of an accident-related traffic status to a second electric vehicle that was previously assigned a less favorable charging station in terms of space or time.

Preferably, the creating of the global charging schedule involves minimizing the sum of the length of driving and the length of charging. The minimized sum of the length of travel and the length of charging goes hand in hand with the quickest possible reaching of the destination. It is noted that the minimizing of the sum can relate to the electric vehicle by itself and/or to the plurality of electric vehicles. The minimizing of the sum regarding the plurality of electric vehicles can be understood as a collective boundary condition. It ensures that no sum of a first electric vehicle will be minimized to the disproportionate detriment of the sum of a second electric vehicle, thus ensuring a balance within the plurality of electric vehicles.

Further preferably, the electric vehicle determines a travel route for the trip depending on the data determining the identified charging station. In other words, the electric vehicle automatically adapts the travel route to the particular charging station. It is noted that the travel route so determined may involve a detour as a result of the adaptation, if the electric vehicle will reach the destination sooner, despite the detour, than when charging the traction battery by a charging station situated along the planned travel route.

Advantageously, the central backend server registers each electric vehicle of the plurality of electric vehicles and/or each charging station of the plurality of charging stations. The registered electric vehicles and/or charging stations take part in the operating method of the charging infrastructure and form the basis for the global charging schedule created by the central backend server.

The registering of the electric vehicle can involve a memorizing of the storage capacity of the traction battery of the electric vehicle and the central backend server can create the global charging schedule in dependence on the memorized storage capacity. Thanks to the registration, the central backend server gains knowledge of vehicle parameters, not definitively and merely as an example knowledge of the storage capacity of the traction battery, which are relevant to the charging of the traction battery, especially the length of charging or the maximum range of the electric vehicle.

The registering of the charging station can involve a memorizing of the position of the charging station and the charging capacity of the charging station and the central backend server can create the global charging schedule in dependence on the memorized position and the memorized charging capacity. Thanks to the registration, the central backend server gains knowledge of charging station parameters, for example not definitively and merely as an example knowledge of the charging capacity of the charging station, which are relevant to the charging of the traction battery, especially the length of charging or the maximum charging current of the charging station.

The registered vehicle parameters and the registered charging station parameters allow the central backend server to create a precise global charging schedule in regard to the capabilities and needs of the electric vehicles and charging stations involved.

Advantageously, each electric vehicle of the plurality of electric vehicles transmits to the central backend server the position of the electric vehicle, the state of charge of the traction battery of the electric vehicle, the starting location of a trip of the electric vehicle, the destination of the trip of the electric vehicle, and the planned travel route for the trip of the electric vehicle and the central backend server creates the global charging schedule in dependence on the transmitted positions, states of charge, starting locations, destinations and planned travel routes of all electric vehicles. Briefly put, each electric vehicle transmits current vehicle parameters to the central backend server. The current driving parameters include, not conclusively and merely as an example, the respective positions, states of charge, starting locations, destinations, and the respectively planned travel routes. The driving parameters transmitted make it possible for the central backend server to dynamically create the global charging schedule in real time.

In one embodiment, the central backend server reserves the particular charging station according to the global charging schedule during a length of charging for the electric vehicle in dependence on the memorized storage capacity and the transmitted state of charge. Thanks to the reservation, the particular charging station is blocked for a charging which deviates from the global charging schedule. Of course, the central backend server can release the reserved charging station if the electric vehicle is hindered from a charging of the traction battery scheduled by the global charging schedule, for example due to an accident-related traffic status. Thanks to the reservation, the efficiency of the operating method is further increased.

In another embodiment, the central backend server creates the global charging schedule in dependence on reservations made for charging stations. The central backend server in this way avoids a multiple occupancy of the charging stations.

The central backend server creates the global charging schedule advantageously by way of a genetic algorithm. The genetic algorithm in particular supports a flexible adapting of the global charging schedule so created to unforeseen events.

Yet another embodiment of the disclosure is a charging infrastructure for electric vehicles, comprising a plurality of charging stations and a central backend server connected to the charging stations. The charging infrastructure is widespread and accordingly allows for many diverse applications of the disclosure.

According to the disclosure, the charging infrastructure for electric vehicles, comprising a plurality of charging stations and a central backend server connected to the charging stations, is adapted to carry out a method according to the disclosure together with a plurality of electric vehicles. The charging infrastructure avoids or at least shortens the waiting time needed for the plurality of electric vehicles prior to charging of the traction battery. In this way, the plurality of electric vehicles can reach the destinations of trips sooner, i.e., interruptions of the trips needed for the charging can be shorter, so that the acceptance of the electric vehicles is increased.

One major benefit of the method according to the disclosure is that waiting times at charging stations of a charging infrastructure prior to charging of traction batteries of electric vehicles are avoided or at least shortened. Because of this, the acceptance of electric vehicles is increased. Furthermore, it is advantageous that the method can achieve great precision and good flexibility in regard to a collective allocation of charging stations to electric vehicles.

### BRIEF DESCRIPTION OF THE SEVERAL VIEWS OF THE DRAWINGS

The disclosure is represented schematically with the aid of one embodiment in the drawings and shall be further described with reference to the drawings.

The FIGURE shows a view of a charging infrastructure according to one embodiment of the invention for electric vehicles.

### DETAILED DESCRIPTION

The FIGURE shows a view of a charging infrastructure 1 according to one embodiment of the invention for electric vehicles 2. The charging infrastructure 1 comprises a plurality of charging stations 10 and a central backend server 11 connected to the charging stations 10 and it is suitable for a plurality of electric vehicles 2. The charging infrastructure 1 is adapted to carry out a method described below according to one embodiment of the invention together with the plurality of electric vehicles 2.

The method serves for operating the charging infrastructure 1.

The central backend server 11 preferably registers each electric vehicle 2 of the plurality of electric vehicles 2. The registering of the electric vehicle 2 can involve a memorizing of the storage capacity 200 of the traction battery 20 of the electric vehicle 2.

The central backend server 11 further preferably registers each charging station 10 of the plurality of charging stations 10. The registering of the charging station 10 can involve a memorizing of the position 100 of the charging station 10 and the charging capacity 101 of the charging station 10.

Specifically, each electric vehicle 2 of the plurality of electric vehicles 2 can transmit to the central backend server 11 the position 22 of the electric vehicle 2, the state of charge 201 of the traction battery 20 of the electric vehicle 2, the starting location 210 of a trip of the electric vehicle 2, the destination of the trip 211 of the electric vehicle 2, and the planned travel route 21 for the trip of the electric vehicle 2.

The central backend server 11 dynamically creates in real time a global charging schedule 3 for the plurality of electric vehicles 2 including the electric vehicle 2 and for the plurality of charging stations 10 of the charging infrastructure 1 including the one particular charging station 10.

Preferably, the central backend server 11 creates the global charging schedule 3 by way of a genetic algorithm 110.

The central backend server 11 can create the global charging schedule 3 in dependence on the transmitted positions 22, states of charge 201, starting locations 210, destinations 211 and planned travel routes 21 of all electric vehicles 2.

The creating of the global charging schedule 3 can involve a minimizing of the sum of the length of driving 212 and the length of charging 102.

The central backend server 11 creates the global charging schedule 3 especially in dependence on the memorized storage capacity 200 of the traction battery 20. The central backend server 11 creates the global charging schedule 3 especially in dependence on the memorized position 100 and the memorized charging capacity 101 of the charging station 10. The central backend server 11 creates the global charging schedule 3 especially in dependence on reservations 112 made for charging stations 10.

The central backend server 11 determines the particular charging station 10 with the aid of the global charging schedule 3 so created and sends data 111 determining the charging station 10 so identified to the electric vehicle 2.

Moreover, the central backend server 11 can reserve the particular charging station 10 according to the global charging schedule 3 during a length of charging 212 for the electric vehicle 2 in dependence on the memorized storage capacity 200 and the transmitted state of charge 201.

The electric vehicle 2 drives during a trip from a starting location 210 to a destination 211 to the particular charging station 10 of the charging infrastructure 1. The electric vehicle 2 can determine a travel route 21 for the trip in dependence on the data 111 determining the charging station 10 so identified.

The particular charging station 10 charges a traction battery 20 of the electric vehicle 2 which is connected to the particular charging station 10.

German patent application no. 102022106823.4, filed Mar. 23, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method of operating a charging infrastructure for a plurality of electric vehicles, the method comprising:
creating, by a central backend server of the charging infrastructure, a global charging schedule for the plurality of electric vehicles and for a plurality of charging stations of the charging infrastructure;
determining, by the central backend server of the charging infrastructure, a particular one of a plurality of charging stations using the global charging schedule;
sending, by the central backend server of the charging infrastructure, data indicating the particular one of the plurality of charging stations to one of the plurality of electric vehicles; and
charging, by the particular one of the plurality of charging stations of the charging infrastructure, a traction battery of the one of the plurality of electric vehicles that is connected to the particular one of the plurality of charging stations.

2. The method according to claim 1, wherein:
the creating of the global charging schedule includes minimizing a sum of a length of driving and a length of charging, and
the method further comprises:
determining, by the one of the plurality of electric vehicles, a travel route for a trip based on the data indicating the particular one of the plurality of charging stations.

3. The method according to claim 1, further comprising:
registering, by the central backend server, each of the plurality of electric vehicles and each of the plurality of charging stations.

4. The method according to claim 3 wherein the registering of the one of the plurality of electric vehicles includes storing a storage capacity of the traction battery of the one of the plurality of electric vehicles, and wherein the creating of the global charging schedule is based on the storage capacity.

5. The method according to claim 3, wherein the registering of the particular one of the plurality of charging stations includes storing a position and a charging capacity of the particular one of the plurality of charging stations, and wherein the creating of the global charging schedule is based on the position and the charging capacity of the particular one of the plurality of charging stations.

6. The method according to claim 1, further comprising:
transmitting, by each electric vehicle of the plurality of electric vehicles, to the central backend server a position of the electric vehicle, a traction battery state of charge, a starting location of a trip of the electric vehicle, a destination of the trip of the electric vehicle, and a planned travel route for the trip of the electric vehicle, wherein the creating of the global charging schedule is based on the position, state of charge, starting location, destination, and planned travel route transmitted by each electric vehicle of the plurality of electric vehicles.

7. The method according to claim 6, further comprising:
reserving, by the central backend server, the particular one of the plurality of charging stations according to the global charging schedule for a length of charging for the one of the plurality of electric vehicles based on a traction battery storage capacity and the traction battery state of charge transmitted by one of the plurality of electric vehicles.

8. The method according to claim 1, wherein the creating of the global charging schedule is based on a plurality of reservations made for the plurality of charging stations.

9. The method according to claim 1, wherein the creating of the global charging schedule includes using a genetic algorithm.

10. A charging infrastructure for a plurality of electric vehicles, comprising:
a plurality of charging stations; and
a central backend server connected to the plurality of charging stations,
wherein the central backend server, in operation,
creates a global charging schedule for the plurality of electric vehicles and for the plurality of charging stations of the charging infrastructure,
determines a particular one of the plurality of charging stations using the global charging schedule, and
sends data indicating the particular one of the plurality of charging stations to one of the plurality of electric vehicles, and
wherein the particular one of the plurality of charging stations, in operation,
charges a traction battery of the one of the plurality of electric vehicles that is connected to the particular one of the plurality of charging stations.
